(19) United States
(12) Patent Application Publication
(10) Pub. No.: US 2015/0214625 A1
(43) Pub. Date: Jul. 30, 2015

(54) ANTENNA BOARD

(71) Applicant: KYOCERA CIRCUIT SOLUTIONS, INC., Yasu-shi (JP)

(72) Inventor: Yoshinobu SAWA, Moriyama-shi (JP)

(73) Assignee: KYOCERA CIRCUIT SOLUTIONS, INC., Yasu-shi (JP)

(21) Appl. No.: 14/603,626

(22) Filed: Jan. 23, 2015

(30) Foreign Application Priority Data
Jan. 30, 2014 (JP) 2014-016204
Oct. 27, 2014 (JP) 2014-218221

(51) Int. Cl. H01Q 9/04

(52) U.S. Cl. CPC H01Q 9/0407

(57) ABSTRACT

The antenna board of the present invention includes: a dielectric board where a plurality of dielectric layers are laminated, a ground conductor layer, a strip conductor, a first patch conductor, a second patch conductor, a third patch conductor, and a penetration conductor. The first patch conductor, the second patch conductor, and the third patch conductor are electrically independent of each other. The penetration conductor includes at least two penetration conductors aligned adjacent to each other in the extending direction of the strip conductor.

### BACKGROUND OF THE INVENTION

1. Field of the Invention

The present invention relates to an antenna board which is formed by laminating dielectric layers and conductor layers.

2. Description of Related Art

As indicated by the cross-sectional view and top view shown in FIGS. 14A and 14B, respectively, and the exploded perspective view shown in FIG. 15, for example, an antenna board includes a dielectric board 11 in which a plurality of dielectric layers 11a to 11e are laminated, a ground conductor layer 12 for shielding, a strip conductor 13 for inputting and outputting high-frequency signals, and a patch conductor 14 for transmitting and receiving electromagnetic waves.

The dielectric board 11 is, for example, formed by the five layers of the dielectric layers 11a to 11e being laminated vertically. The dielectric layers 11a to 11e are formed by, for example, a resin layer with glass cloth and a resin without glass cloth. The ground conductor 12 is deposited on the entire bottom surface of the dielectric layer 11a located on the bottom layer. The around conductor 12 includes, for example, copper. The strip conductor 13 is opposed to the ground conductor 12 across the dielectric layer 11a, and is disposed between the dielectric layers 11a and 11b. The strip conductor 13 is a narrow strip-shaped conductor extending in one direction from the outer peripheral edge to the central part in the inner part of the dielectric board 11, and includes an end part in the central part of the dielectric board 11. The strip conductor 13 includes, for example, copper.

The patch conductor 14 includes a first patch conductor 14a, a second patch conductor 14b, and a third patch conductor 14c. These patch conductors 14a to 14c have quadrangle shapes. The patch conductors 14a to 14c include, for example, copper.

The first patch conductor 14a is disposed between the dielectric layers 11c and 11d so as to cover the position of the end part 13a of the strip conductor 13. The first patch conductor 14a is connected to the end part 13a of the strip conductor 13 via a penetration conductor 15 penetrating the dielectric layer 11c and a penetration conductor 16 penetrating the dielectric layer 11b.

The second patch conductor 14b is disposed between the dielectric layers 11d and 11e so as to cover the position where the first patch conductor 14a is formed. The second patch conductor 14b is electrically independent. The third patch conductor 14c is disposed on the top surface of the dielectric layer 11e so as to cover the position where the second patch conductor 14b is formed. The third patch conductor 14c is electrically independent.

In this antenna board, when a high-frequency signal is supplied to the strip conductor 13, the signal is transmitted to the first patch conductor 14a via the penetration conductors 15 and 16. The signal is radiated as an electromagnetic wave to the outside via the first patch conductor 14a, the second patch conductor 14b and the third patch conductor 14c. By the way, the reason why the antenna board like this includes the electrically independent second patch conductor 14b and third patch conductor 14c as well as the first patch conductor 14a is that the bandwidth of the frequency band of the antenna can be widened by such a configuration. Such a conventional antenna board is described, for example, in Japanese Unexamined Patent Application Publication No. H5-145327.

However, for example, in the wireless personal area network, the frequency band to be used is different in each country, and it is required to cover the wide frequency band so that one antenna board is usable in the whole world. To achieve this, an antenna board with a frequency band further wider than the conventional antenna board is required to be provided.

### SUMMARY

It is an object of the present invention to provide a wide band antenna board which is capable of transmitting and receiving a satisfactory signal in a wide frequency band.

The antenna board of the present invention includes: a first dielectric layer; a strip conductor disposed on a top surface of the first dielectric layer so as to have an end part, extending towards the end part; a ground conductor layer disposed on a bottom surface side of the first dielectric layer; a second dielectric layer laminated on a top surface side of the first dielectric layer and the strip conductor; a first patch conductor disposed on a top surface of the second dielectric layer so as to cover a position of the end part of the strip conductor; a third dielectric layer laminated on the second dielectric layer and the first patch conductor; a second patch conductor disposed on a top surface of the third dielectric layer so that at least part of the second patch conductor covers a position where the first patch conductor is formed, being electrically independent; a fourth dielectric layer laminated on the third dielectric layer and the second patch conductor; a third patch conductor disposed on a top surface of the fourth dielectric layer so that at least part of the third patch conductor covers a position where the second patch conductor is formed, being electrically independent; and a penetration conductor connecting the end part and the first patch conductor by penetrating the second dielectric layer, and the at least one penetration conductor includes at least two penetration conductors aligned adjacent to each other in the extending direction of the strip conductor.

According to the antenna board of the present invention, the penetration conductor formed to connect the end part of the strip conductor and the first patch conductor disposed across the second dielectric layer includes at least two penetration conductors aligned adjacent to each other in the extending direction of the strip conductor. Thus, by the at least two penetration conductors disposed in this manner, a complex resonance occurs satisfactorily in the first to third patch conductors. Therefore, it is possible to provide a broadband antenna board that can transmit and receive a satisfactory signal in a wide frequency band.

### BRIEF DESCRIPTION OF THE DRAWINGS

FIGS. 1A and 1B are a cross-sectional view and a top view, respectively, showing an antenna board according to a first preferred embodiment of the present invention;

FIG. 2 is an exploded perspective view of the antenna board shown in FIGS. 1A and 1B;

FIG. 3 is a graph showing a result of a simulation of return losses of a signal by using an analysis model by the antenna board of the present invention shown in FIGS. 1A and 1B and an analysis model by a conventional antenna board shown in FIGS. 14A and 14B;

FIGS. 4A and 4B are a cross-sectional view and a top view, respectively, showing an antenna board according to a second preferred embodiment of the present invention;

FIG. 5 is a graph showing a result of a simulation of return losses of a signal by using an analysis model by the antenna board of the present invention shown in FIGS. 4A and 4B and an analysis model by the conventional antenna board shown in FIGS. 14A and 14B;

FIGS. 6A and 6B are a cross-sectional view and a top view, respectively, showing an antenna board according to a third preferred embodiment of the present invention;

FIG. 7 is a graph showing a result of a simulation of return losses of a signal by using an analysis model by the antenna board of the present invention shown in FIGS. 6A and 6B and an analysis model by the conventional antenna board shown in FIGS. 14A and 14B;

FIGS. 8A and 8B are a cross-sectional view and a top view, respectively, showing an antenna board according to a fourth preferred embodiment of the present invention;

FIG. 9 is a graph showing a result of a simulation of return losses of a signal by using an analysis model by the antenna board of the present invention shown in FIGS. 8A and 8B and an analysis model by the conventional antenna board shown in FIGS. 14A and 14B;

FIGS. 10A and 10B are a cross-sectional view and a top view, respectively, showing an antenna board according to a fifth preferred embodiment of the present invention;

FIG. 11 is a graph showing a result of a simulation of return losses of a signal by using an analysis model by the antenna board of the present invention shown in FIGS. 10A and 10B and an analysis model by the conventional antenna board shown in FIGS. 14A and 14B;

FIGS. 12A and 12B are a cross-sectional view and a top view, respectively, showing an antenna board according to a sixth preferred embodiment of the present invention;

FIG. 13 is a graph showing a result of a simulation of return losses of a signal by using an analysis model by the antenna board of the present invention shown in FIGS. 12A and 12B and an analysis model by the conventional antenna board shown in FIGS. 14A and 14B;

FIGS. 14A and 14B are a cross-sectional view and a top view, respectively, showing a conventional antenna board; and

FIG. 15 is an exploded perspective view of the antenna board shown in FIGS. 14A and 14B.

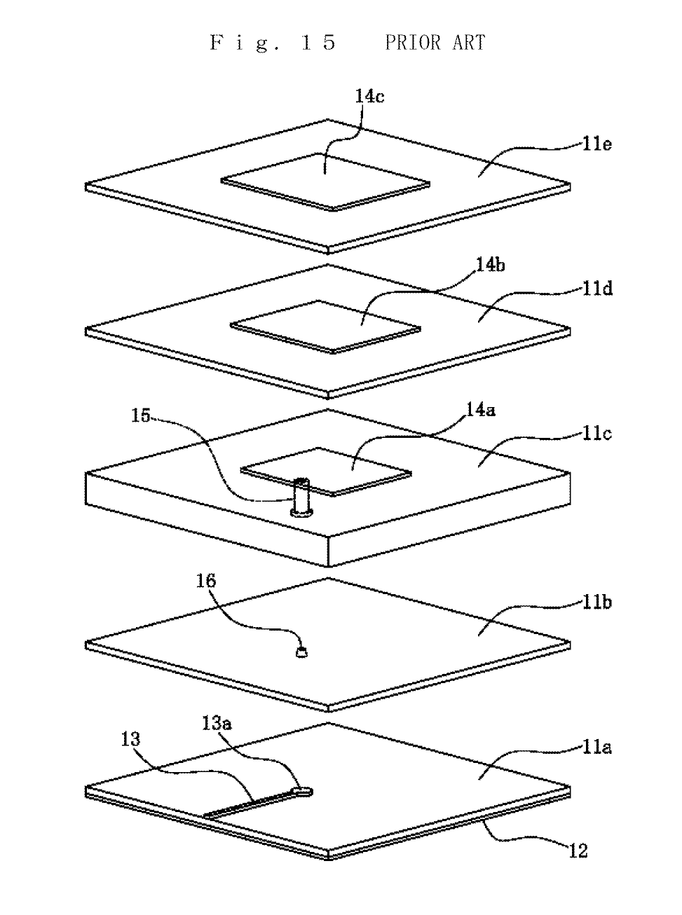

### DETAILED DESCRIPTION

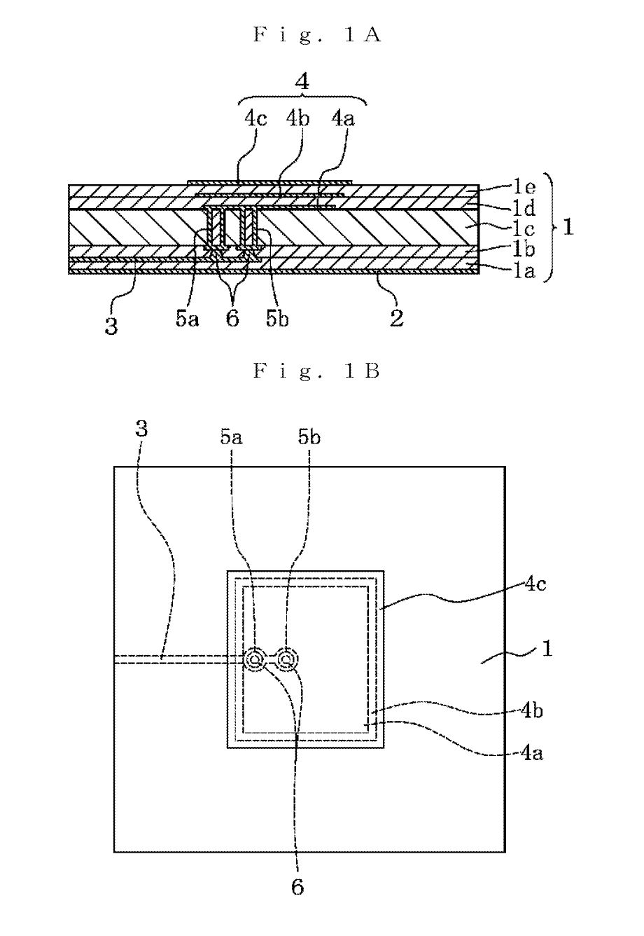

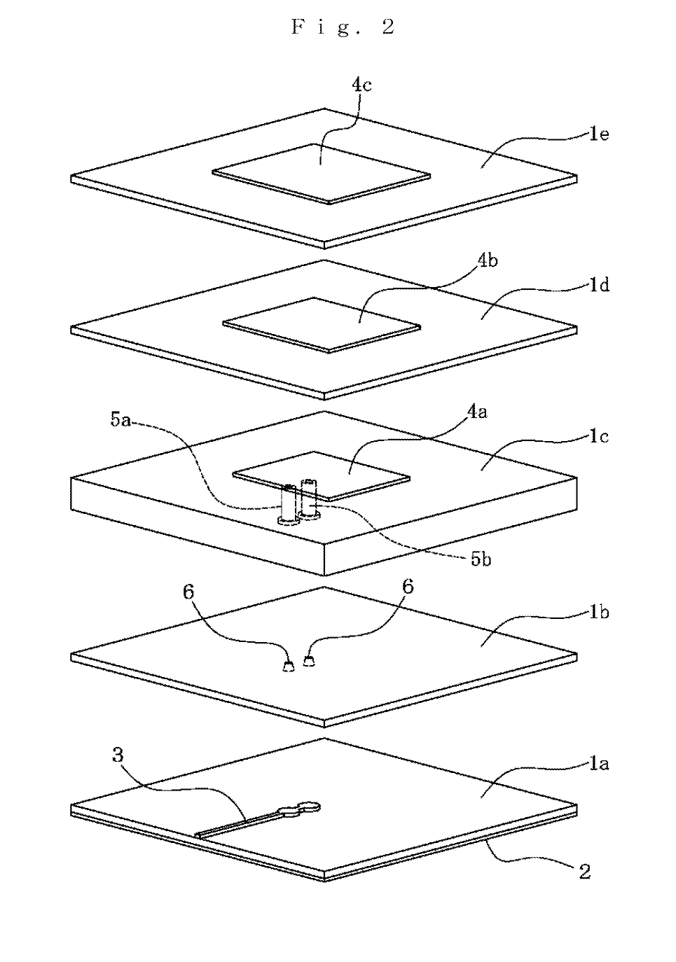

Next, a first preferred embodiment of an antenna board according to the present invention will be described based on FIGS. 1A, 1B and 2. This antenna board includes a dielectric board 1 in which a plurality of dielectric layers 1a to 1e are laminated, a ground conductor layer 2 for shielding, a strip conductor 3 for inputting and outputting high-frequency signals, and a patch conductor 4 for transmitting and receiving electromagnetic waves as indicated by a cross-sectional view and a top view shown in FIGS. 1A and 1B, respectively, and an exploded perspective view shown in FIG. 2.

The dielectric layers 1a to 1e include, for example, a dielectric material of a resin having the glass cloth impregnated with a thermosetting resin such as an epoxy resin, a bismaleimide triazine resin, and an allyl modified polyphenylene ether resin. Each of the dielectric layers 1a to 1e has the thickness of about 30 to 100 μm. The dielectric layers 1a to 1e have the dielectric constants of about 3 to 5. The dielectric layers 1a to 1e include a first dielectric layer 1a, an intermediate dielectric layer 1b, a second dielectric layer 1c, a third dielectric layer 1d, and a fourth dielectric layer 1e, respectively.

The ground conductor 2 is deposited on the entire bottom surface of the first dielectric layer 1a formed on the bottom layer. The ground conductor 2 functions as a shielding. The ground conductor 2 has the thickness of about 5 to 20 μm. The ground conductor 2 includes, for example, copper.

The strip conductor 3 is opposed to the ground conductor 2 across the first dielectric layer 1a, and is disposed between the first dielectric layer 1a and the intermediate dielectric layer 1b. The strip conductor 3 is a narrow strip-shaped conductor including an end part 3a in the central part of the dielectric board 1, and extends in one direction (hereinafter referred to as “extending direction”) to the end part 3a in the inner part of the dielectric board 1. The strip conductor 3 functions as a transmission line for inputting and outputting a high-frequency signal in the antenna board of the present invention, and a high-frequency signal is transmitted to the strip conductor 3. The strip conductor 3 has the width of about 50 to 350 μm. The strip conductor 3 has the thickness of about 5 to 20 μm. The strip conductor 3 includes, for example, copper.

The patch conductor 4 includes a first patch conductor 4a, a second patch conductor 4b, and a third patch conductor 4c. These patch conductors 4a to 4c are electrically independent of each other. The patch conductors 4a to 4c include quadrangle shapes having the sides parallel to the extending direction of the strip conductor 3 (hereinafter referred to as “longitudinal side”) and the sides parallel to a direction perpendicular to the extending direction (hereinafter referred to as “lateral side”). Each side of the patch conductors 4a to 4c has the length of about 0.5 to 5 mm. Each of the patch conductors 4a to 4c has the thickness of about 5 to 20 μm. Each of the patch conductors 4a to 4c includes, for example, copper.

The first patch conductor 4a is disposed between the second dielectric layer 1c and the third dielectric layer 1d so as to cover the position of the end part 3a of the strip conductor 3. Therefore, between the first patch conductor 4a and the strip conductor 3, two layers of the dielectric layers 1b and 1c are interposed.

The first patch conductor 4a is connected to the end part 3a of the strip conductor 3 via penetration conductors 5a and 5b penetrating the second dielectric layer 1c and penetration conductors 6 penetrating the intermediate dielectric layer 1b. The two penetration conductors 5a and 5b are disposed and aligned adjacent to each other in the extending direction of the strip conductors 3, and have a columnar shape with the diameter of about 30 to 200 μm, or a cylindrical shape with the thickness of about 5 to 20 μm and the diameter of about 30 to 200 μm. The center-to-center distance of the two penetration conductors 5a and 5b is about 50 to 300 μm. The penetration conductors 6 have a columnar shape or a truncated cone shape with the diameter of about 30 to 100 μm. Each of the penetration conductors 5a, 5b, and 6 includes, for example, copper. In addition, the first patch conductor 4a radiates an electromagnetic wave to the outside by receiving the supply of a high-frequency signal from the strip conductor 3. Alternatively, the first patch conductor 4a leads the strip conductor 3 to generate a high-frequency signal by receiving an electromagnetic wave from the outside.

The second patch conductor 4b is disposed between the third dielectric layer 1d and the fourth dielectric layer 1e so as to cover the position where the first patch conductor 4a is formed. Thereby, the second patch conductor 4b is capacitively coupled with the first patch conductor 4a across the third dielectric layer 1d. By receiving an electromagnetic wave from the first patch conductor 4a, the second patch conductor 4b radiates to the outside an electromagnetic wave corresponding to the received electromagnetic wave. Alternatively, by receiving an electromagnetic wave from the outside, the second patch conductor 4b supplies the first patch conductor 4a with an electromagnetic wave corresponding to the received electromagnetic wave. Each side of the second patch conductor 4b is preferred to be equal to or larger than the corresponding side of the first patch conductor 4a by about up to 0.5 mm.

The third patch conductor 4c is disposed on a top surface of the fourth dielectric layer 1e of the uppermost layer so as to cover the position where the second patch conductor 4b is formed. Thereby, the third patch conductor 4c is capacitively coupled with the second patch conductor 4b across the fourth dielectric layer 1e. By receiving an electromagnetic wave from the second patch conductor 4b, the third patch conductor 4c radiates to the outside an electromagnetic wave corresponding to the received electromagnetic wave. Alternatively, by receiving an electromagnetic wave from the outside, the third patch conductor 4c supplies the second patch conductor 4b with an electromagnetic wave corresponding to the received electromagnetic wave. Each side of the third patch conductor 4c is preferred to be equal to or larger than the corresponding side of the second patch conductor 4b by about up to 0.5 mm.

In the antenna board of the present invention, it is important that the two penetration conductors 5a and 5b connecting the strip conductors 3 and the first patch conductor 4a are disposed and aligned adjacent to each other in the extending direction of the strip conductor 3. By the two penetration conductors 5a and 5b disposed in this manner, a complex resonance in the first to third patch conductors occurs satisfactorily. Therefore, it is possible to provide a broadband antenna board capable of transmitting and receiving a satisfactory signal in a wide frequency band.

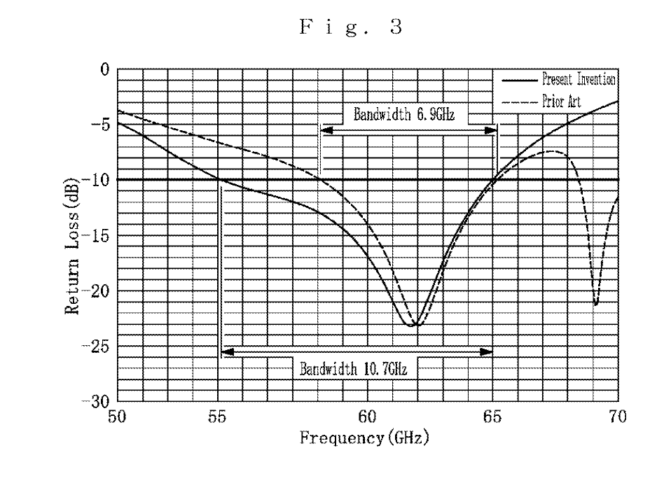

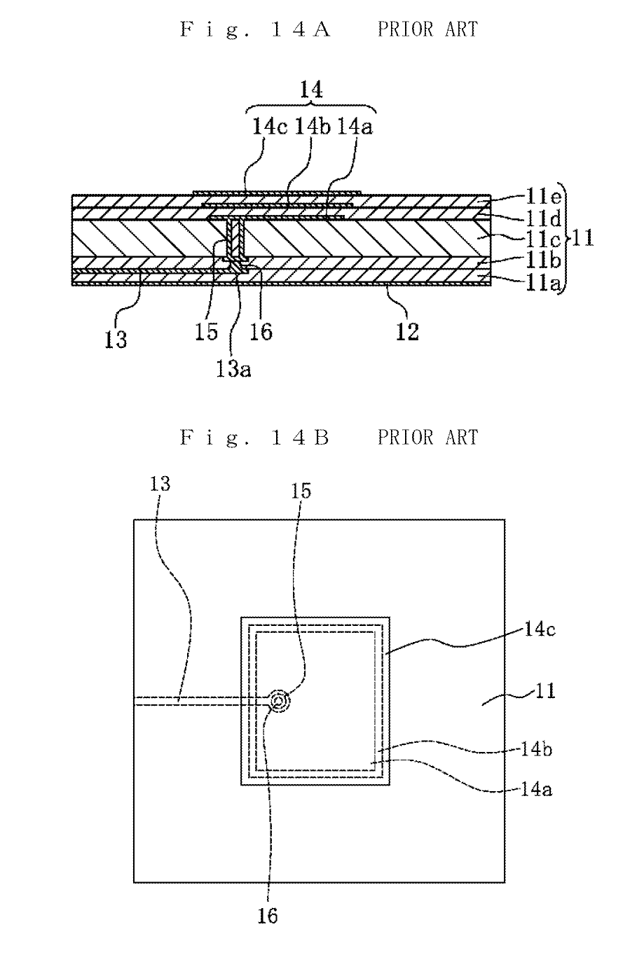

In analysis models where the antenna board of the first preferred embodiment shown in FIGS. 1A and 1B and the conventional antenna board shown in FIGS. 14A and 14B were modeled, the return losses were simulated by an electromagnetic field simulator when a high-frequency signal was input into a strip conductor. The results are shown in FIG. 3. In FIG. 3, the graph indicated by the solid line is the return loss of the analysis model by the antenna board of the first preferred embodiment, and the graph shown by the broken line is the return loss of the analysis model by the conventional antenna board. In FIG. 3, the frequency bandwidth of the return loss of −10 dB, which is indicated by the thick graduation mark, or less is required to be as wide as possible. As is apparent in FIG. 3, in the analysis model by the conventional antenna board, the frequency bandwidth of the return loss of −10 dB or less which is required by an antenna board is a narrow bandwidth of about 6.9 GHz. In contrast, in the analysis model by the antenna board of the first preferred embodiment, the frequency bandwidth of the return loss of −10 dB or less is found to be a broad bandwidth of about 10.7 GHz.

The simulation conditions were as follows. In the analysis model by the antenna board of the first preferred embodiment, each of the dielectric layers 1a to 1e shown in FIGS. 1A and 1B had the dielectric constant of 3.35. Each of the dielectric layers 1a, 1b, 1d and 1e had the thickness of 50 μm, and the dielectric layer 1c had the thickness of 100 μm. The strip conductor 3, the ground conductor layer 2 and the patch conductors 4a to 4c were formed by copper, and each of them had the thickness of 18 μm. The strip conductor 3 had the width of 85 μm and the length of 3 mm, and was disposed so as to extend in one direction from the outer peripheral edge to the central part of the dielectric board 1 between the dielectric layers 1a and 1b, and so that the end part 3a was positioned in the central part of the dielectric board 1. In the end part 3a of the strip conductor 3, two circular land patterns of 180 μm in diameter were disposed at the center-to-center distance of 200 μm.

As for the first patch conductor 4a, the longitudinal side parallel to the extending direction of the strip conductor 3 had the length of 1 mm, and the lateral side perpendicular to this had the length of 1.4 mm. The first patch conductor 4a and the land pattern disposed on the end part 3a of the strip conductor 3 were connected by the penetration conductors 5a and 5b having columnar shapes of 90 μm in diameter and the penetration conductors 6 having columnar shapes of 90 μm in diameter. The connection positions of the penetration conductors 5a and 5b were respectively the positions, where the centers of the penetration conductors 5a and 5b were disposed, at 50 μm and 200 μm from the lateral side on the side to which the strip conductor 3 extended in the center between the two longitudinal sides of the first patch conductor 4a. The penetration conductors 5a, 5b, and 6 were formed by copper.

As for the second patch conductor 4b, the longitudinal side parallel to the extending direction of the strip conductor 3 had the length of 1 mm, and the lateral side perpendicular to this had the length of 1.5 mm. The second patch conductor 4b was disposed so that the position of its center overlaps the position of the center of the first patch electrode 4a.

As for the third patch conductor 4c, the longitudinal side parallel to the extending direction of the strip conductor 3 had the length of 1.2 mm, and the lateral side perpendicular to this had the length of 1.6 mm. The third patch conductor 4c was disposed so that the position of its center overlaps the position of the center of the first patch conductor 4a and the position of the center of the second patch conductor 4b.

As for the analysis model by the conventional antenna board, a model was used which was entirely identical with the analysis model by the antenna board of the first preferred embodiment except that only one land pattern was disposed at the end part 3a of the strip conductor 3, and that only the penetration conductor 5a and the penetration conductor 6 to be connected to this was disposed.

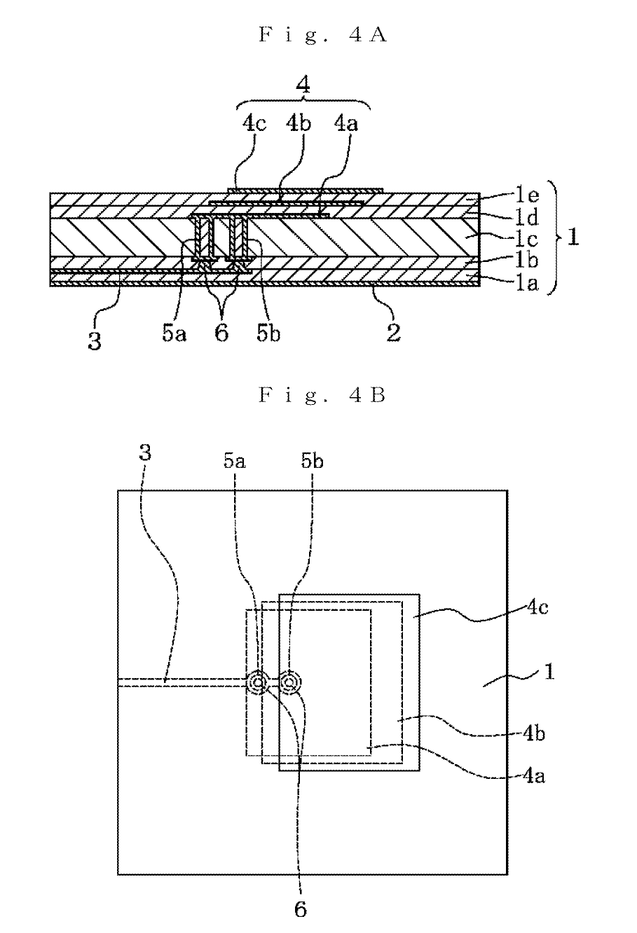

Next, the second preferred embodiment of an antenna board according to the present invention will be described with reference to FIGS. 4A and 4B. It should be noted that in the antenna board of the second preferred embodiment, the portions common to the antenna board of the first preferred embodiment are denoted by the same reference characters of the antenna board of the first preferred embodiment, and that its detailed description will be omitted.

Compared with the antenna board of the first preferred embodiment, in the antenna board of the second preferred embodiment, there are differences in that the center of the second patch conductor 4b is deviated with respect to the center of the first patch conductor 4a in the extending direction of the strip conductor 3, and that the center of the third patch conductor 4c is deviated with respect to the center of the second patch conductor 4b in the extending direction of the strip conductors 3. The deviation of the second patch conductor 4b is set to the extent that it covers 80% or more of the area of the position where the first patch conductor 4a is formed. The deviation of the third patch conductor 4c is set to the extent that it covers 80% or more of the area of the position where the second patch conductor 4b is formed. The rest are the same as those of the antenna board of the first preferred embodiment. When the patch conductor is a quadrangle, the center of the patch conductor refers to the intersection of the two diagonals.

According to the antenna board of the second preferred embodiment, the first patch conductor 4a, the second patch conductor 4b, and the third patch conductor 4c are disposed to be deviated from each other in the extending direction of the strip conductors 3. Thus, a more complex resonance occurs satisfactorily in the first to third patch conductors 4a to 4c disposed in this manner. Therefore, it is possible to provide a broadband antenna board that can transmit and receive a satisfactory signal in a wide frequency band.

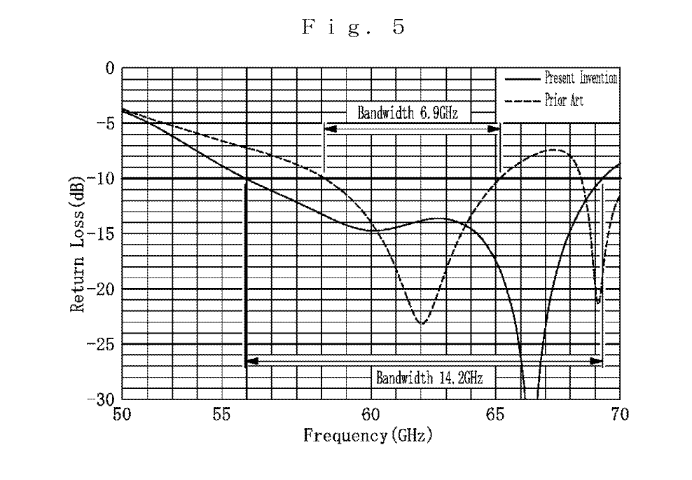

In analysis models where the antenna board of the second preferred embodiment shown in FIGS. 4A and 4B and the conventional antenna board shown in FIGS. 14A and 14B were modeled, the return losses were simulated by an electromagnetic field simulator when a high-frequency signal was input into a strip conductor. The results are shown in FIG. 5. In FIG. 5, the graph indicated by the solid line is the return loss of the analysis model by the antenna board of the second preferred embodiment, and the graph shown by the broken line is the return loss of the analysis model by the conventional antenna board. In FIG. 5, the frequency bandwidth of the return loss of −10 dB, which is indicated by the thick graduation mark, or less is required to be as wide as possible. As is apparent in FIG. 5, in the analysis model by the conventional antenna board, the frequency bandwidth of the return loss of −10 dB or less which is required by an antenna board is a narrow bandwidth of about 6.9 GHz. In contrast, in the analysis model by the antenna board of the second preferred embodiment, the frequency bandwidth of the return loss of −10 dB or less is found to be a broad bandwidth of about 14.2 GHz.

As for the analysis model by the antenna board of the second preferred embodiment, compared with the analysis model by the antenna board of the first preferred embodiment, a model was used which was entirely identical with the analysis model by the antenna board of the first preferred embodiment except that the position of the second patch conductor 4b and the position of the third patch conductor 4c were different. The center position of the second patch conductor 4b was disposed to be deviated from the center position of the first patch conductor 4a in the extending direction of the strip line 3 so that the second patch conductor 4b covered the 90% of the area of the position where the first patch conductor 4a was formed. The center position of the third patch conductor 4c was disposed to be deviated from the center position of the second patch conductor 4b in the extending direction of the strip line 3 so that the third patch conductor 4c covered the 90% of the area of the position where the second patch conductor 4b was formed.

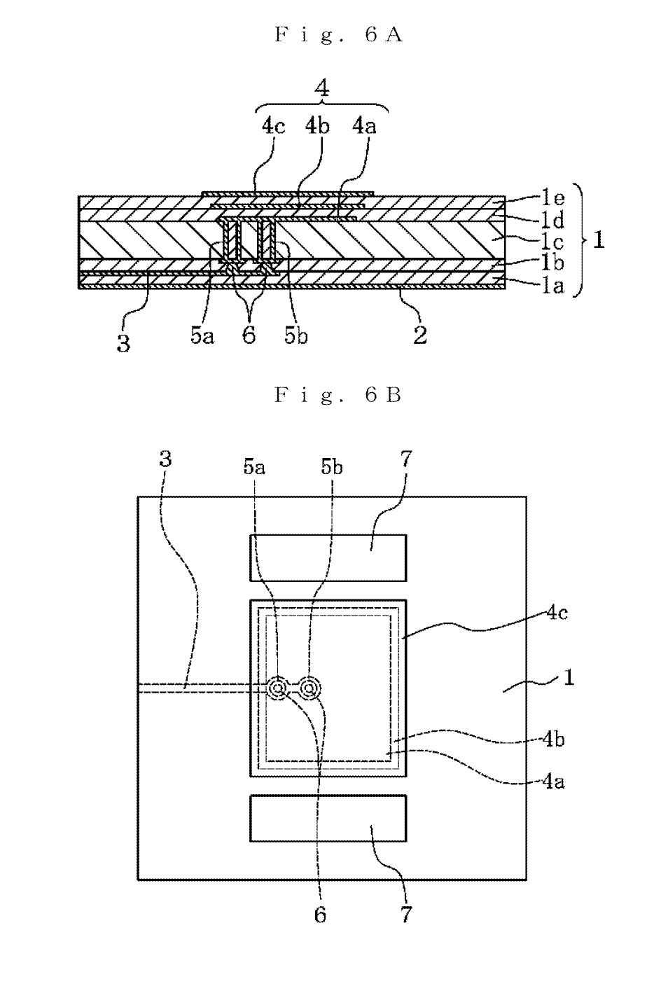

Next, a third preferred embodiment of an antenna board according to the present invention will be described with reference to FIGS. 6A and 6B. It should be noted that in the antenna board of the third preferred embodiment, the portions common to the antenna board of the first preferred embodiment are denoted by the same reference characters of the antenna board of the first preferred embodiment, and that its detailed description will be omitted.

Compared with the antenna board of the first preferred embodiment, in the antenna board of the third preferred embodiment, there is a difference in that auxiliary patch conductors 7 are disposed on the top surface of the fourth dielectric layer 1e located on the uppermost layer. The auxiliary patch conductors 7 are disposed one by one at intervals of about 0.1 to 1 mm from the third patch conductor 4c on each side of the third patch conductor 4c in the direction orthogonal to the extending direction of the strip conductors 3. The auxiliary patch conductors 7 have a quadrangle shape having the longitudinal sides parallel to the longitudinal sides of the third patch conductor 4c, the lateral sides parallel to the lateral sides of the third patch conductor 4c, and each one side with the length of about 0.1 to 5 mm. The auxiliary patch conductors 7 are disposed so as not to cover the positions where the first patch conductor 4a and the second patch conductor 4b are formed. The auxiliary patch conductors 7 include, for example, copper in the same manner as the patch conductors 4. The rest are the same as those of the antenna board of the first preferred embodiment.

According to the antenna board of the third preferred embodiment, the antenna board includes the auxiliary patch conductor 7 disposed on each side of the third patch conductor 4c in the direction orthogonal to the extending direction of the strip conductors 3 so that the auxiliary patch conductors 7 do not cover the positions where the first patch conductor 4a and the second patch conductor 4b are formed. Thus, a more complex resonance occurs satisfactorily in the first to third patch conductors 4a to 4c and the auxiliary patch conductors 7 disposed in this manner. Therefore, it is possible to provide a broadband antenna board that can transmit and receive a satisfactory signal in a wide frequency band.

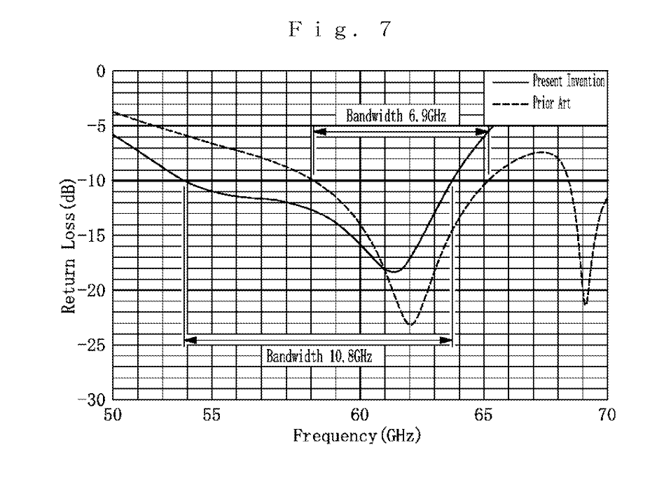

In analysis models where the antenna board of the third preferred embodiment shown in FIGS. 6A and 6B and the conventional antenna board shown in FIGS. 14A and 14B were modeled, the return losses were simulated by an electromagnetic field simulator when a high-frequency signal was input into a strip conductor. The results are shown in FIG. 7. In FIG. 7, the graph indicated by the solid line is the return loss of the analysis model by the antenna board of the third preferred embodiment, and the graph shown by the broken line is the return loss of the analysis model by the conventional antenna board. In FIG. 7, the frequency bandwidth of the return loss of −10 dB, which is indicated by the thick graduation mark, or less is required to be as wide as possible. As is apparent in FIG. 7, in the analysis model by the conventional antenna board, the frequency bandwidth of the return loss of −10 dB or less which is required by an antenna board is a narrow bandwidth of about 6.9 GHz. In contrast, in the analysis model by the antenna board of the third preferred embodiment, the frequency bandwidth of the return loss of −10 dB or less is found to be a broad bandwidth of about 10.8 GHz.

As for the analysis model by the antenna board of the third preferred embodiment, compared with the analysis model by the antenna board of the first preferred embodiment, a model was used which was entirely identical with the analysis model by the antenna board of the first preferred embodiment except that the auxiliary patch conductors 7 were disposed. The auxiliary patch conductor 7 was formed of copper, which had the longitudinal side parallel to the extending direction of the strip conductor 3 with the length of 1.1 mm, and the lateral side perpendicular to this with the length of 0.5 mm. The auxiliary patch conductors 7 were disposed one by one on each side of the third patch conductor 4c in the longer side direction by the longitudinal sides being aligned right beside the longitudinal sides of the third patch conductor 4c. The distance between the third patch conductor 4c and auxiliary patch conductor 7 was 0.35 mm.

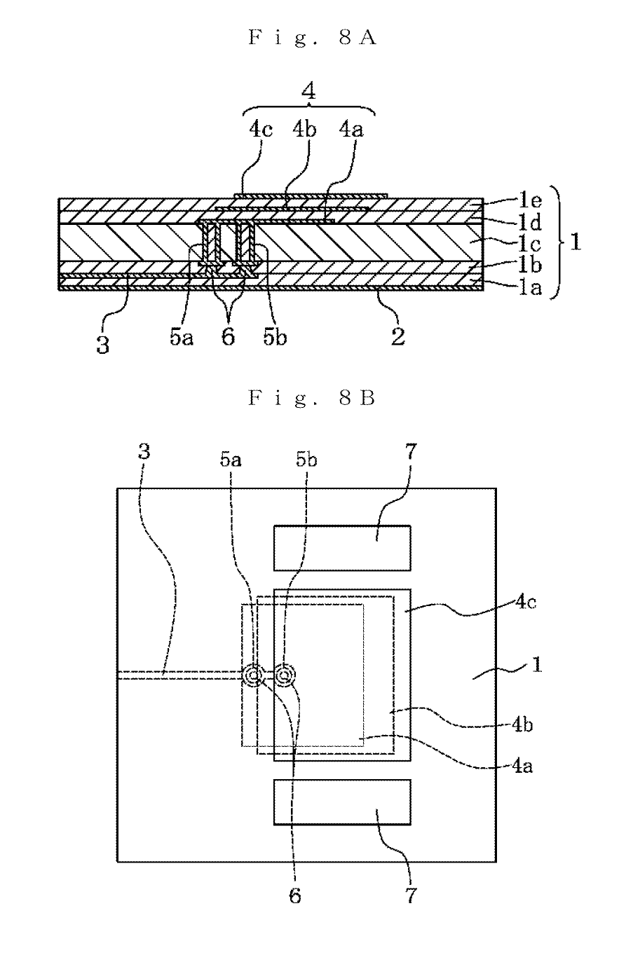

Next, a fourth preferred embodiment of an antenna board according to the present invention will be described with reference to FIGS. 8A and 8B. It should be noted that in the antenna board of the fourth preferred embodiment, the portions common to the antenna board of the second preferred embodiment are denoted by the same reference characters of the antenna board of the second preferred embodiment, and that its detailed description will be omitted.

Compared with the antenna board of the second preferred embodiment, in the antenna board of the fourth preferred embodiment, there is a difference in that auxiliary patch conductors 7 are disposed on the top surface of the fourth dielectric layer 1e located on the uppermost layer. The details of the auxiliary patch conductors 7 are as described above, and the description will be omitted. The rest are the same as those of the antenna board of the second preferred embodiment.

According to the antenna board of the fourth preferred embodiment, the first patch conductor 4a, the second patch conductor 4b, and the third patch conductor 4c are disposed to be deviated from each other in the extending direction of the strip conductors 3, and the antenna board includes the auxiliary patch conductor 7 on each side of the third patch conductor 4c in a direction orthogonal to the extending direction of the strip conductors 3 so as not to cover the positions where the first patch conductor 4a and the second patch conductor 4b are formed. Thus, a more complex resonance occurs satisfactorily in the first to third patch conductors 4a to 4c and the auxiliary patch conductors 7 disposed in this manner. Therefore, it is possible to provide a broadband antenna board that can transmit and receive a satisfactory signal in a wide frequency band.

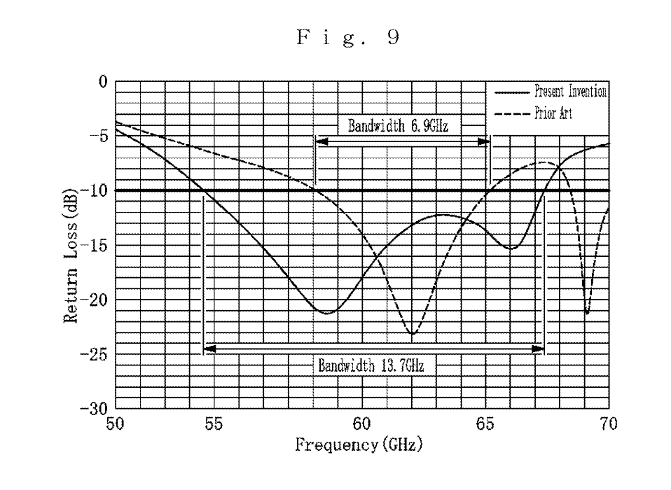

In analysis models where the antenna board of the fourth preferred embodiment shown in FIGS. 8A and 8B and the conventional antenna board shown in FIGS. 14A and 14B were modeled, the return losses were simulated by an electromagnetic field simulator when a high-frequency signal was input into a strip conductor. The results are shown in FIG. 9. In FIG. 9, the graph indicated by the solid line is the return loss of the analysis model by the antenna board of the fourth preferred embodiment, and the graph shown by the broken line is the return loss of the analysis model by the conventional antenna board. In FIG. 9, the frequency bandwidth of the return loss of −10 dB, which is indicated by the thick graduation mark, or less is required to be as wide as possible. As is apparent in FIG. 9, in the analysis model by the conventional antenna board, the frequency bandwidth of the return loss of −10 dB or less which is required by an antenna board is a narrow bandwidth of about 6.9 GHz. In contrast, in the analysis model by the antenna board of the fourth preferred embodiment, the frequency bandwidth of the return loss of −10 dB or less is found to be a broad bandwidth of about 13.7 GHz.

As for the analysis model by the antenna board of the fourth preferred embodiment, compared with the analysis model by the antenna board of the second preferred embodiment, a model was used which was entirely identical with the analysis model by the antenna board of the second preferred embodiment except that the auxiliary patch conductors 7 were disposed. The auxiliary patch conductor 7 was formed of copper, which had the longitudinal side parallel to the extending direction of the strip conductor 3 with the length of 1.1 mm, and the lateral side perpendicular to this with the length of 0.5 mm. The auxiliary patch conductors 7 were disposed one by one on each side of the third patch conductor 4c in the longer side direction by the longitudinal sides being aligned right beside the longitudinal sides of the third patch conductor 4c. The distance between the third patch conductor 4c and auxiliary patch conductor 7 was 0.3 mm.

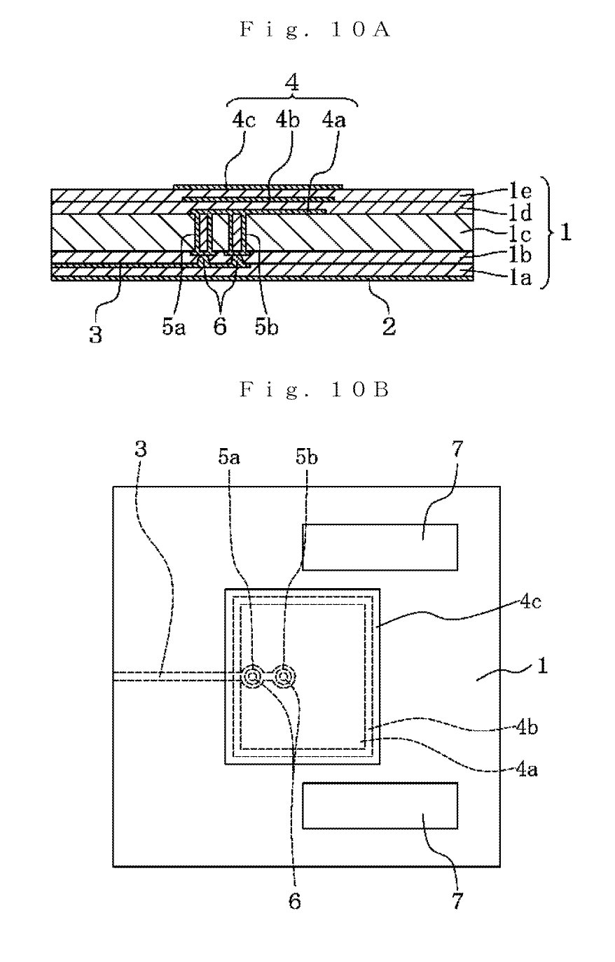

Next, a fifth preferred embodiment of an antenna board according to the present invention will be described with reference to FIGS. 10A and 10B. It should be noted that in the antenna board of the fifth preferred embodiment, the portions common to the antenna board of the third preferred embodiment are denoted by the same reference characters of the antenna board of the third preferred embodiment, and that its detailed description will be omitted.

Compared with the antenna board of the third preferred embodiment, in the antenna board of the fifth preferred embodiment, there is a difference in that the auxiliary patch conductors 7 are deviated in the extending direction of the strip conductors 3 with respect to the third patch conductor 4c. The auxiliary patch conductors 7 are deviated to the extent that about half of the longitudinal side protrudes in the extending direction of the strip conductor 3 from the third patch conductor 4c. The rest are the same as those of the antenna board of the third preferred embodiment.

According to the antenna board of the fifth preferred embodiment, the auxiliary patch conductors 7 are deviated in the extending direction of the strip conductor 3 with respect to the third patch conductor 4c. Thus, a more complex resonance occurs satisfactorily in the first to third patch conductors 4a to 4c and the auxiliary patch conductors 7 disposed in this manner. Therefore, it is possible to provide a broadband antenna board that can transmit and receive a satisfactory signal in a wide frequency band.

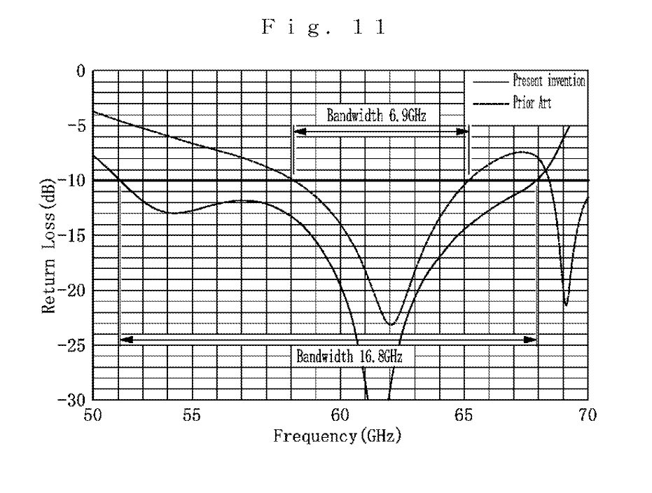

In analysis models where the antenna board of the fifth preferred embodiment shown in FIGS. 10A and 105 and the conventional antenna board shown in FIGS. 14A and 14B were modeled, the return losses were simulated by an electromagnetic field simulator when a high-frequency signal was input into a strip conductor. The results are shown in FIG. 11. In FIG. 11, the graph indicated by the solid line is the return loss of the analysis model by the antenna board of the fifth preferred embodiment, and the graph shown by the broken line is the return loss of the analysis model by the conventional antenna board. In FIG. 11, the frequency bandwidth of the return loss of −10 dB, which is indicated by the thick graduation mark, or less is required to be as wide as possible. As is apparent in FIG. 11, in the analysis model by the conventional antenna board, the frequency bandwidth of the return loss of −10 dB or less which is required by an antenna board is a narrow bandwidth of about 6.9 GHz. In contrast, in the analysis model by the antenna board of the fifth preferred embodiment, the frequency bandwidth of the return loss of −10 dB or less is found to be a broad bandwidth of about 16.8 GHz.

As for the analysis model by the antenna board of the fifth preferred embodiment, compared with the analysis model by the antenna board of the third preferred embodiment, a model was used which was entirely identical with the analysis model by the antenna board of the third preferred embodiment except that the auxiliary patch conductors 7 were deviated to protrude 0.5 mm in the extending direction of the strip conductor 3 from the third patch conductor 4c.

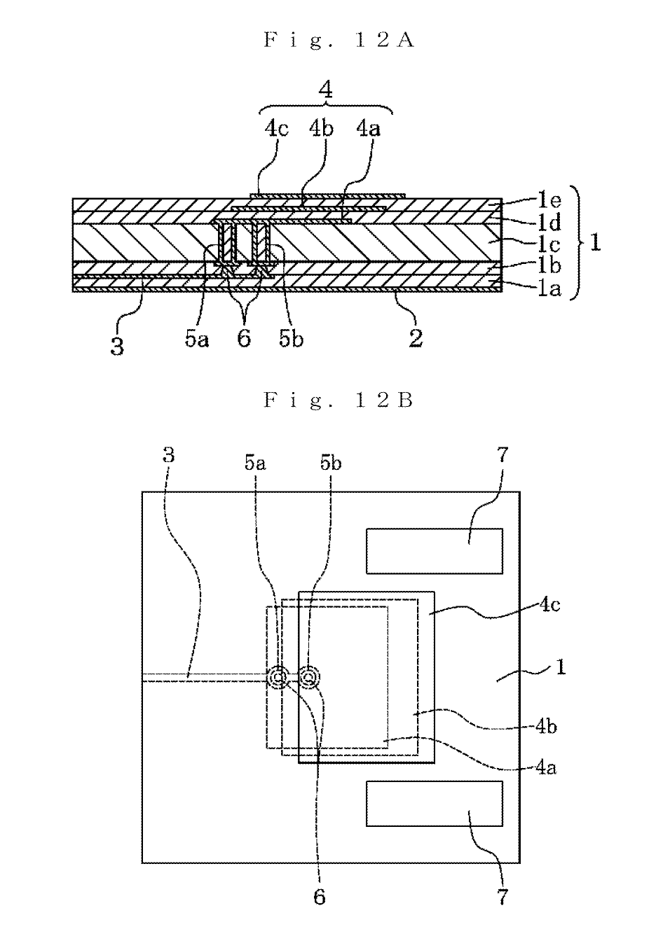

Next, a sixth preferred embodiment of an antenna board according to the present invention will be described with reference to FIGS. 12A and 12B. It should be noted that in the antenna board of the sixth preferred embodiment, the portions common to the antenna board of the fourth preferred embodiment are denoted by the same reference characters of the antenna board of the fourth preferred embodiment, and that its detailed description will be omitted.

Compared with the antenna board of the fourth preferred embodiment, in the antenna board of the sixth preferred embodiment, there is a difference in that the auxiliary patch conductors 7 are deviated in the extending direction of the strip conductors 3 with respect to the third patch conductor 4c. The auxiliary patch conductors 7 are deviated to the extent that about half of the longitudinal side protrudes in the extending direction of the strip conductor 3 from the third patch conductor 4c. The rest are the same as those of the antenna board of the fourth preferred embodiment.

According to the antenna board of the sixth preferred embodiment, the auxiliary patch conductors 7 are deviated in the extending direction of the strip conductor 3 with respect to the third patch conductor 4c. Thus, more complex resonance occurs satisfactorily in the first to third patch conductors 4a to 4c and the auxiliary patch conductors 7 disposed in this manner. Therefore, it is possible to provide a broadband antenna board that can transmit and receive a satisfactory signal in a wide frequency band.

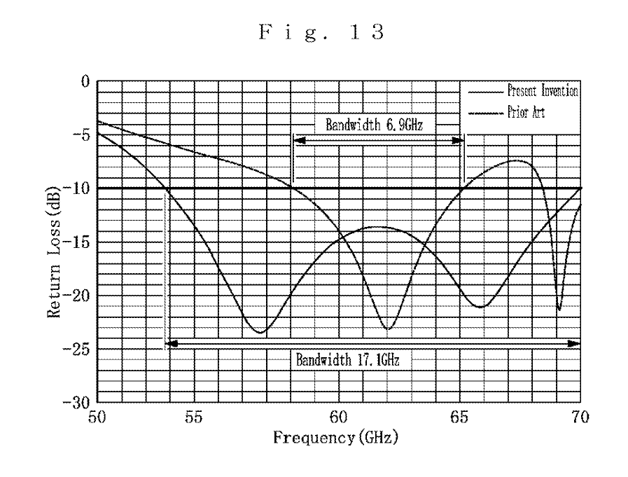

In analysis models where the antenna board of the sixth preferred embodiment shown in FIGS. 12A and 12B and the conventional antenna board shown in FIGS. 14A and 14B were modeled, the return losses were simulated by an electromagnetic field simulator when a high-frequency signal was input into a strip conductor. The results are shown in FIG. 13. In FIG. 13, the graph indicated by the solid line is the return loss of the analysis model by the antenna board of the sixth preferred embodiment, and the graph shown by the broken line is the return loss of the analysis model by the conventional antenna board. In FIG. 13, the frequency bandwidth of the return loss of −10 dB, which is indicated by the thick graduation mark, or less is required to be as wide as possible. As is apparent in FIG. 13, in the analysis model by the conventional antenna board, the frequency bandwidth of the return loss of −10 dB or less which is required by an antenna board is a narrow bandwidth of about 6.9 GHz. In contrast, in the analysis model by the antenna board of the sixth preferred embodiment, the frequency bandwidth of the return loss of −10 dB or less is found to be a broad bandwidth of about 17.1 GHz.

As for the analysis model by the antenna board of the sixth preferred embodiment, compared with the analysis model by the antenna board of the fourth preferred embodiment, a model was used which was entirely identical with the analysis model by the antenna board of the fourth preferred embodiment except that the auxiliary patch conductors 7 were deviated to protrude 0.5 mm in the extending direction of the strip conductor 3 from the third patch conductor 4c.

When the auxiliary patch conductors 7 are formed so as to protrude from the third patch conductor 4c in the extending direction of the strip conductor 3 as in the antenna board of the fifth and sixth preferred embodiments, it is preferred that the auxiliary patch conductors 7 are deviated to the extent that the whole of the auxiliary patch conductors 7 do not protrude from the third patch conductor 4c in the extending direction of the strip conductor 3. This is because if the whole of the auxiliary patch conductors 7 are disposed to be deviated so as to protrude from the third patch conductor 4c in the extending direction of the strip conductor 3, it becomes difficult to widen the frequency bandwidth of the return loss of −10 db or less, more than the frequency bandwidths of the antenna board of the fifth and sixth preferred embodiments.

The present invention is not intended to be limited to the embodiments described above, and various modifications are possible within the scope described in the claims. Although, the patch conductors 4 and the auxiliary patch conductors 7 have quadrangle shapes in the first to sixth preferred embodiments described above, they may have other shapes such as circular shapes and polygonal shapes other than quadrangle shapes.

What is claimed is:

1. An antenna board comprising:
a first dielectric layer;
a strip conductor disposed on a top surface of the first dielectric layer so as to have an end part, extending towards the end part;
a ground conductor layer disposed on a bottom surface side of the first dielectric layer;
a second dielectric layer laminated on a top surface side of the first dielectric layer and the strip conductor;
a first patch conductor disposed on a top surface of the second dielectric layer so as to cover a position of the end part of the strip conductor;
a third dielectric layer laminated on the second dielectric layer and the first patch conductor;
a second patch conductor disposed on a top surface of the third dielectric layer so that at least part of the second patch conductor covers a position where the first patch conductor is formed, being electrically independent;
a fourth dielectric layer laminated on the third dielectric layer and the second patch conductor;
a third patch conductor disposed on a top surface of the fourth dielectric layer so that at least part of the third patch conductor covers a position where the second patch conductor is formed, being electrically independent; and
a penetration conductor connecting the end part of the strip conductor and the first patch conductor by penetrating the second dielectric layer,
wherein the penetration conductor comprises at least two penetration conductors aligned adjacent to each other in the extending direction of the strip conductor.

2. The antenna board according to claim 1,
wherein a center of the second patch conductor is deviated with respect to a center of the first patch conductor in an extending direction of the strip conductor, and
wherein a center of the third patch conductor is deviated with respect to the center of the second patch conductor in the extending direction of the strip conductor.

3. The antenna board according to claim 1,
wherein at least one auxiliary patch conductor is disposed on each side of the third patch conductor in a direction orthogonal to an extending direction of the strip conductor on the top surface of the fourth dielectric layer so as not to cover a position where the third patch conductor is formed, and
wherein the at least one auxiliary patch conductor is electrically independent of the third patch conductor.

4. The antenna board according to claim 3, wherein the at least one auxiliary patch conductor is disposed to be deviated with respect to the third patch conductor in the extending direction of the strip conductor.

5. The antenna board according to claim 2,
wherein at least one auxiliary patch conductor is disposed on each side of the third patch conductor in a direction orthogonal to an extending direction of the strip conductor on the top surface of the fourth dielectric layer so as not to cover a position where the third patch conductor is formed, and
wherein the at least one auxiliary patch conductor is electrically independent of the third patch conductor.

6. The antenna board according to claim 5, wherein the at least one auxiliary patch conductor is disposed to be deviated with respect to the third patch conductor in the extending direction of the strip conductor.

7. The antenna board according to claim 1, wherein the at least two penetration conductors are disposed so as to have a center-to-center distance of 50 to 300 μm.

8. The antenna board according to claim 2, wherein the second patch conductor is disposed so as to cover 80% or more of an area of a position where the first patch conductor is formed.

9. The antenna board according to claim 2, wherein the third patch conductor is disposed so as to cover 80% or more of an area of a position where the second patch conductor is formed.
